(19) United States
(12) Patent Application Publication
(10) Pub. No.: US 2002/0194042 A1
(43) Pub. Date: Dec. 19, 2002

(54) Method of business analysis

(76) Inventor: Donald Alexander Sands, Queensland (AU)

Correspondence Address: CANTOR COLBURN, LLP, 55 GRIFFIN ROAD SOUTH, BLOOMFIELD, CT, 06002

(21) Appl. No.: 10/168,071

(22) PCT Filed: May 10, 2001
(86) PCT No.: PCT/AU01/00532

(30) Foreign Application Priority Data
May 16, 2000 (AU) PQ 7523

(51) Int. Cl. G06F 17/60

(52) U.S. Cl. 705/7

(57) ABSTRACT

A method is taught for processing performance data in a data reporting system (100) having a plurality of business entities (600) and a report center (100) in communications with the plurality of business entities (600). The method includes transmitting by the plurality of business entities (600) to the report center (100) customer performance data indicative of the operation of the business entities (600) during a first day and processing of the customer performance data by the report center (100) to provide processed performance data. Availability of the processed performance data is provided to a select business entity (600) during a second day wherein the time difference between the first day and the second day is less than eleven days. The processed performance data includes processed occupancy data, processed average daily rate data and processed Rev PAR data. The method further includes determining price information in accordance with the processed performance data, pricing a product by selected business entity (600) in accordance with determined price information, and selling the product according to the pricing. The processed performance data can be requested by the selected business entity (600) prior to providing availability of the processed performance data. Data can be transmitted by way of a network data connection and an internet connection.

This invention relates to improvements in management information systems for monitoring performance of a business (multinational corporation, company or small to medium enterprise). In particular, it relates to a modeling and analysis framework that describes a business, and a method of using the framework to analyze the performance of the business and identify opportunities to improve the performance of the business.

### BACKGROUND TO THE INVENTION

Modern management practices highlight the need to monitor and improve the performance of all aspects of a business. This can be achieved by identifying key performance indicators at each level within a business and then monitoring the key performance indicators against target values. The target values can be determined from historical data or by modeling of the relevant aspect of the business. Typically a model is developed for a particular area, say a plant process model or a business process model, and is typically confined to that area. These models are used to forecast expected results for a plant or a business process.

One example of this approach is the familiar budgeting process for financial management. A budget can be set based on historical performance or desired future performance. For a small business the setting of a budget is a relatively straightforward process. For larger businesses the problem is somewhat more intractable and generally dealt with by assigning separate budgets to each operational unit within the business, and perhaps components and sub-components within each unit.

The same approach can be used with every unit, component, and sub-component within a business, whether financial or otherwise. For example, a power generation business may have a range of financial assets and physical assets. One physical asset will be a power generation station that can be considered as a unit of the business. This unit may be made up of a number of power utility components which are in turn made up from a number of sub-components, such as boilers, pumps, heaters, condensers, turbines, etc. Each sub-component can be monitored for deviation from a target performance based on output for resources in. The development of key performance indicators across a business and at all levels within a business is known but it has proven difficult to analyze and draw conclusions from the volume of information that is collected.

Efficient operation of a business requires an understanding of how each unit, component and sub-component is contributing to the overall performance of the business. In an attempt to obtain this understanding large amounts of information concerning the operation of a business are typically gathered and subsequently analysed. No suitable framework for organising and analysing this information exists so it is currently necessary to compress the collected data to a tractable level. Data compression involves combining data from a number of sub-components and/or components into a single indicator to represent the performance of the collated sub-components and/or components. Data compression is not reversible so most of the detailed data on the performance of the business is lost. Furthermore, the absence of a framework for collecting and storing the captured data means that information is stored in a manner that effectively prevents intelligent analysis of the information. Although the current management systems will indicate when a unit, and perhaps a component, is performing below target, the current systems do not allow the captured data to be mined to identify the particular key performance indicators contributing to the underperformance or allow for a structured analysis of where performance improvements can be made.

Other problems associated with present business information systems relate to the lack of integration between different sections of a business. This primarily occurs because different sections such as plant and human resources are typically monitored differently making subsequent integration difficult. By way of example, a plant section involving power unit components may be monitored in one respect by the power output in megawatts. The performance of another section (of the business may be measured in terms of the financial return on shares. Because of the different ways in which these different sections of the business are measured it is difficult to firstly combine them and other sections of the business to determine the overall performance of the business, and secondly to compare their contribution to the overall performance of the business.

It is therefore desirable to provide a method of measuring the overall performance of a business by combining the performance of each of the different sections (units, components, sub-components) of a business and across the various facets of the section (efficiency, reliability, capacity, safety, environmental impact, risk). It is also desirable to provide a method of determining the contribution of different sections of a business to the overall performance of the business and where the best improvements are possible for financial return and risk management.

### DISCLOSURE OF THE INVENTION

In one form, although it need not be the only or indeed the broadest form, the invention resides in a method of monitoring the performance of a business including the steps of:

determining key performance indicators for one or more sections of the business;

determining a target value for each key performance indicator, measuring an actual value for each key performance indicator; measuring a deviation between the target value and the actual value;

storing the actual value and deviation for each key performance indicator;

summing the actual values and the deviations to provide a global measure of performance of the business in terms of a global actual value and a global deviation;

wherein a significant global deviation is tracked to one or more contributing key performance indicators to identify the section and/or sections primarily contributing to the global deviation.

In preference, the step of determining a target value for each key performance indicator includes the steps of selecting an appropriate model, setting parameters for the model, and calculating a target value from an input value.

Improvement of the business can be achieved by simulating changes to the performance and controllable parameters of the model for each section of the business to determine the impact on the overall performance of the business. The value associated with changes in the performance and controllable parameters is put into the same framework so that the system considers the cost-benefit of the change as part of the analysis.

Risk exposure to the business can be achieved by simulating changes to the uncontrollable parameters of the model for each section of the business to determine the impact on the overall performance of the business. The value associated with changes in uncontrollable parameters is put into the same framework so that the system considers the fluctuations in cost of the change as part of the analysis.

In another form the invention resides in a method of monitoring the performance of a business including the steps of:

(a) determining input values Xᵢ for each key performance indicator KPIᵢ for each of one or more sub-components of the business;

(b) converting each input value Xᵢ to corresponding input values Yᵢ that are measured in units which are common for all key performance indicators KPIᵢ;

(c) measuring output values Zᵢ for each Xᵢ;

(d) converting each output value Z_{i.tot} corresponding output values Wᵢ that are measured in units which are common for all key performance indicators KPIᵢ;

(e) calculating a total input Y_{i.tot} for the business which is based on the Yᵢ values of each KPIᵢ and the relationship between each KPIᵢ of the business;

(f) calculating a total output W_{i.tot} for the business which is based on the Wᵢ values of each KPIᵢ and the relationship between each KPIᵢ of the business; and

(g) comparing the total output W_{i.tot} to the total input Y_{i.tot} as a measure of performance of the business.

Suitably W_{i.tot} is calculated as the summation of Wᵢ for all i, and Y_{i.tot} is calculated as the summation of Yᵢ for all i.

The method of monitoring the performance of a business may further include the steps of:

(h) calculating budget output values Bᵢ from the input values Yᵢ and a model for each KPIᵢ;

(i) calculating a deviation value Dᵢ for each KPIᵢ which is the difference between the budget output value Bᵢ and the actual output value Wᵢ;

(j) calculating a total deviation value D_{i.tot} which is based on the Dᵢ values of each KPIᵢ and the relationship between each KPIᵢ of the business;

(k) comparing the total deviation value D_{i.tot} to a threshold T as a measure of performance of the business.

The method may also include the steps of:

(I) calculating a total budget output value B tot which is based on the Bᵢ values of each KPIᵢ and the relationship between each KPIᵢ of the business;

(m) calculating a global deviation G between the total budget output value B_{i.tot} and the total output W_{i.tot} for the business; and

(n) comparing the global deviation value G to a threshold T as a measure of performance of the business.

Suitably B_{i.tot} is calculated as the summation of Bᵢ for all i.

The method may further include the steps of:

(o) mining the deviation values Dᵢ when either the global deviation G or the total deviation value D_{i.tot} exceeds the threshold T to identify the KPIᵢ or KPIᵢ's that contribute to the global deviation G in a significant manner.

The method may also include the step of:

(p) quantifying improvement to the business by systematically changing controllable parameters P_{c} of the model for a KPIᵢ and relating a value of the change to P_{c} to the value associated with W_{i.tot} or D_{i.tot} as a result of the change to P_{c};

and/or may include the step of:

(q) quantifying the risk a business is exposed to by systematically changing uncontrollable parameters Pᵤ of the model for a KPIᵢ within an expected range and relating a value of the change to Pᵤ to the value associated with the W_{i.tot} or D_{i.tot} as a result of the change to Pᵤ.

In a still further form the invention resides in a computer implemented method of monitoring the performance of a business by performing the steps (a) to (g) above and optionally performing one or more of the steps (h) to (q).

### BRIEF DESCRIPTION OF THE DRAWINGS

To assist in understanding the invention, preferred embodiments will be described with reference to the following figures in which:

FIG. 1 is a schematic representation of a business for the purpose of describing the invention;

FIG. 2 shows schematically the hierarchical structure of the business of FIG. 1;

FIG. 3 represents the determination of budget outputs and actual outputs for a given input to a key performance indicator;

FIG. 4 is a flow chart showing the operation of the method;

FIG. 5 is a practical example of the working of the invention; and

FIG. 6 is a schematic of a computer system useful for implementing the invention.

### DETAILED DESCRIPTION OF THE DRAWINGS

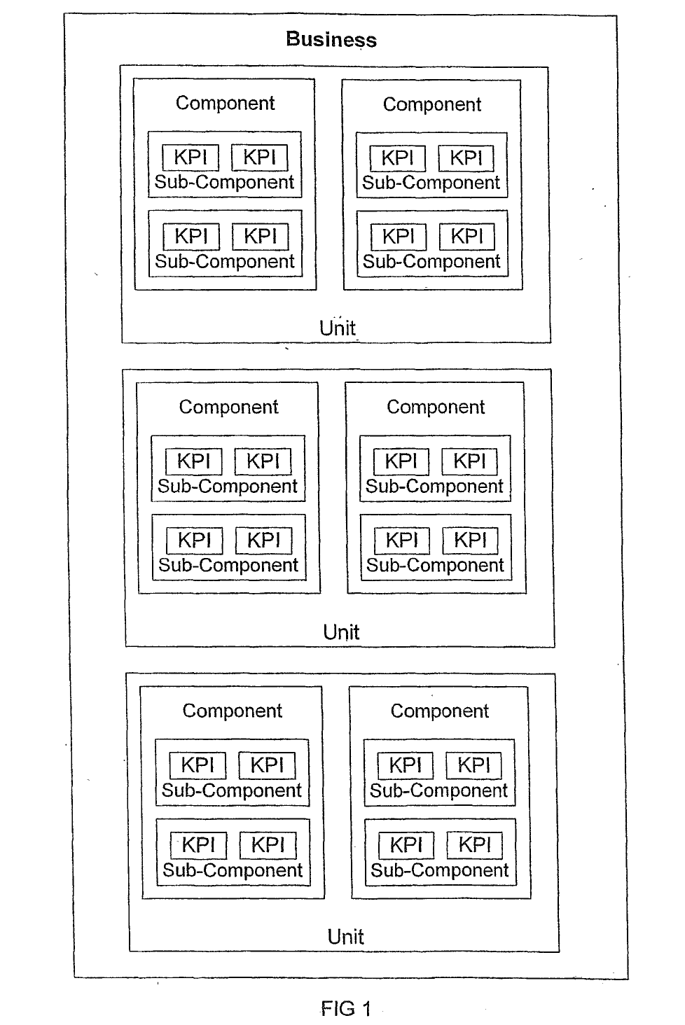

Referring to FIG. 1, there is shown a block diagram that conceptually represents an operating business. The business is made up of a number of operating units. The number of operating units will depend on the size and nature of the business. To effectively work the invention the business should be completely described by the operating units. Operating units may be physical, financial, or other. In the specific example discussed below the business is a power generation utility with a power station as one physical unit and the share register as another financial unit.

Each operating unit is further described in detail as consisting of multiple components, which may be further broken down to sub-components. The performance of the business is measured against a range of key performance indicators (KPI) that apply at the lowest level of the business. Each component (or sub-component) will, have a number of associated key performance indicators that are designed to provide measures of the health of the business. There may also be additional key performance indicators that are calculated at a macro level for components and units.

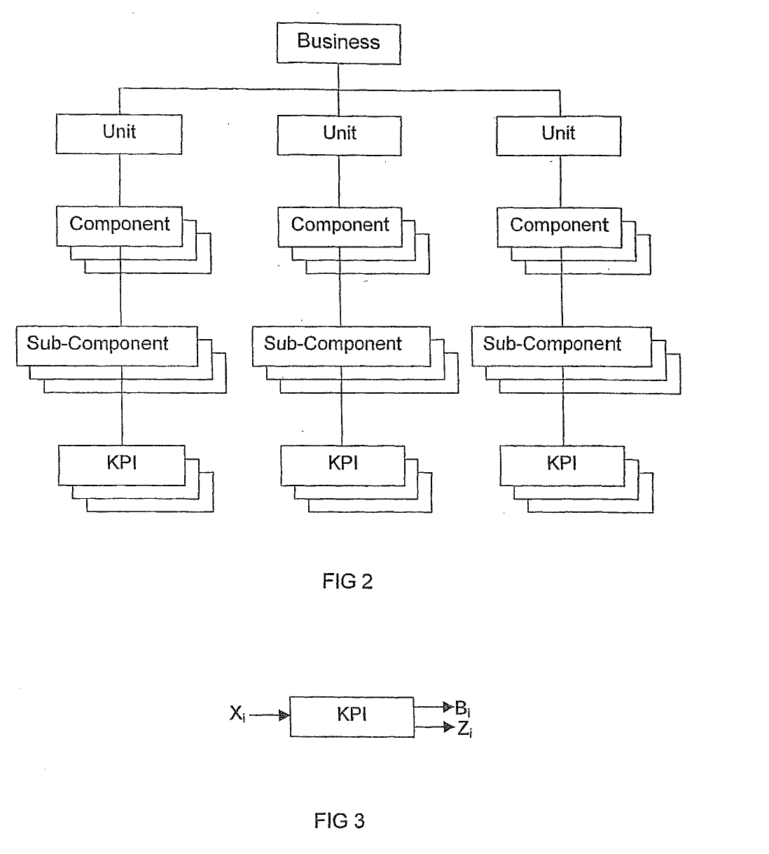

Another representation of the same structure is shown in FIG. 2, but highlighting the hierarchical structure of a business. The performance measured by each KPI is an accumulative measure of the overall performance of the business. Thus, referring to FIG. 3, for each KPI the actual output Zᵢ is monitored relative to the actual input Xᵢ. A budget value Bᵢ is calculated from the actual input Xᵢ for each KPI. The difference between the budget value Bᵢ and the actual output value Zᵢ is an indication of the efficiency.

The budget value is calculated using suitable models for the particular KPI applicable to the sub-component, component or unit. The selected key performance indicators are peripheral to the method of the invention. Persons skilled in the art will be aware of models and management systems based on the key performance indicator concept. This invention is not concerned directly with the key performance indicators, but rather a method of using the key performance indicators to analyze the overall performance of the business at a global level while maintaining information at a local level for detailed analysis.

The actual value and the deviation between the actual and budget values are recorded by the method. The values are summed across the hierarchy to provide the global measure and intermediate values.

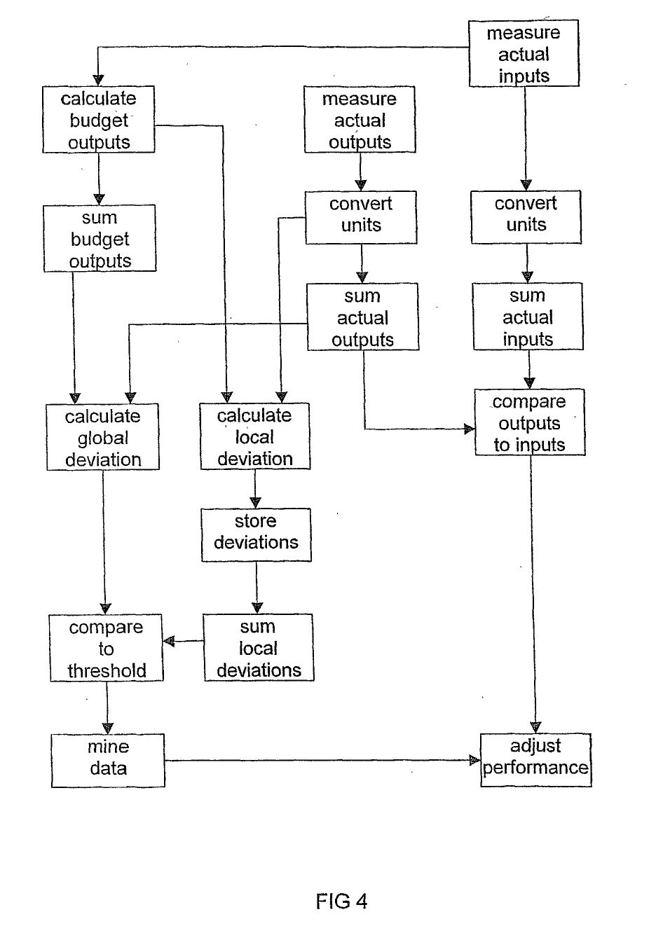

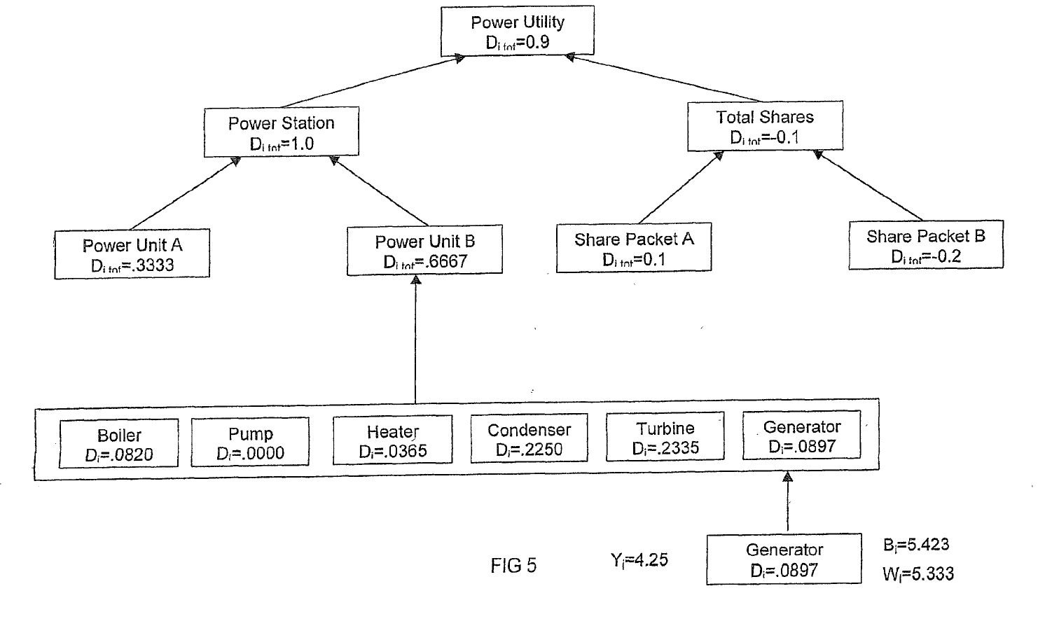

The method is described in greater detail in FIG. 4. As shown in FIG. 4, the method commences with the measurement of the actual input values Xᵢ. The input values Xᵢ will have units appropriate for the KPI. For example, a financial unit will have KPI's measured in dollars whereas a physical unit will have KPI's measured in, for example, Megawatts or kilograms of produce, etc. In order to allow comparison (; between units and summation of global indicators it is necessary to convert the Xᵢ values to a common value base. The inventors have found that a financial basis is most appropriate. Therefore, the Xᵢ values are converted to Yᵢ values measured in dollars.

Although financial units provide an appropriate common basis for implementing the invention it should be understood that the invention is not limited to conversion of measured values to financial units. Any other basis is acceptable if conversion to the selected common units is possible. For those units already using the selected common units the conversion process will be unity process (no conversion or multiplication by one).

The converted input values Y, may be summed across KPI's to give a sub-component input value, which may in turn be summed to give a component input value, a unit input value and a total business input value, Y_{i.tot}.

The actual output Zᵢ from each KPI is measured and converted to the same common units to give a converted value Wᵢ. The converted values Wᵢ may be summed to give total values W_{i.tot} at the sub-component, component, unit, and business level. At each level the total measured output values W_{i.tot} and the total input values Y_{i.tot} can be compared to give a first indication of the performance of the business. By systematically changing controllable parameters P_{c} and determining the influence on W_{i.tot}, local and global optimization is possible from within the same analysis structure. By systematically changing the uncontrollable parameters Pᵤ and determining the influence on W_{i.tot}, the risk that the business is exposed to due to uncontrollable influences can be estimated from within the same analysis structure.

As seen in FIG. 4, the measured inputs Xᵢ are used to calculate budget outputs Bᵢ. The budget outputs are expressed in the selected common unit. The calculation of the budget input will normally require conversion of the measured inputs to the appropriate units. A budget output (target performance) for an engineering component may be based on the design performance of the component, a non-engineering component target performance may be based on other performance indicators like rate of return, earnings before interest, or earnings before tax.

A local deviation Dᵢ for each KPI is calculated by comparing the converted actual output Wᵢ with the calculated budget output Bᵢ. The local deviations Dᵢ are stored and summed to provide total deviations D_{i.tot} at the sub-component, component, unit, or and business level. At the business level the total deviation D_{i.tot} is compared to a threshold T to determine if the business is operating within acceptable limits. A deviation greater than the acceptable threshold is an indication of some aspect of the business performing at an unacceptably inefficient level. The stored data is mined through the hierarchical structure depicted in FIG. 2 to determine the specific sub-component that is under-performing. Corrective action may then be taken.

The method depicted in FIG. 4 also provides for a global measure of efficiency G to be determined by calculating the difference between the summed total B_{i.tot} of the individual budget outputs Bᵢ and the summed total W_{i.tot} of the converted actual outputs Wᵢ. The global efficiency value G is compared to a threshold T which may be the same threshold as discussed above. If the value G is greater than the threshold T the stored deviation data is mined to identify the problem component or sub-component. Efficiency values G can be determined at each level within the business, depending on the level of management adopted.

As indicated in FIG. 4, the method leads to adjustment of performance to correct or improve the deviation. How performance is adjusted does not form part of the invention. Persons skilled in management of individual business units will appreciate the manner in which correction of operating conditions in a component can impact on the overall performance of a business. The invention quantifies the impact of the improvement

The method described above facilitates simple evaluation of the performance of a business yet maintains detailed information on performance at all levels of a business. It therefore substantially overcomes the data compression problems discussed earlier. Furthermore, it greatly reduces the amount of analysis, and therefore time, required to identify the cause of a deviation from budget and to seek improvements available from changes to controllable parameters. The method provides a structured mechanism to allocate limited resources to rectification of performance deviations and provide performance improvements across an entire business structure to the greatest benefit of the business.

As the method is component based a business can change its portfolio of components without changing the method. Individual components, and the parts of the hierarchy below that component, can be activated and deactivated to reflect the changes in the business. This makes maintenance of the method a straightforward task.

In complex businesses, the strict hierarchical structure shown in FIG. 2 may be difficult to establish. Some units may involve inputs from components or sub-components used in other units. The method provides links between common components to pass output values between components since a common system of units, eg dollars, is used throughout the system.

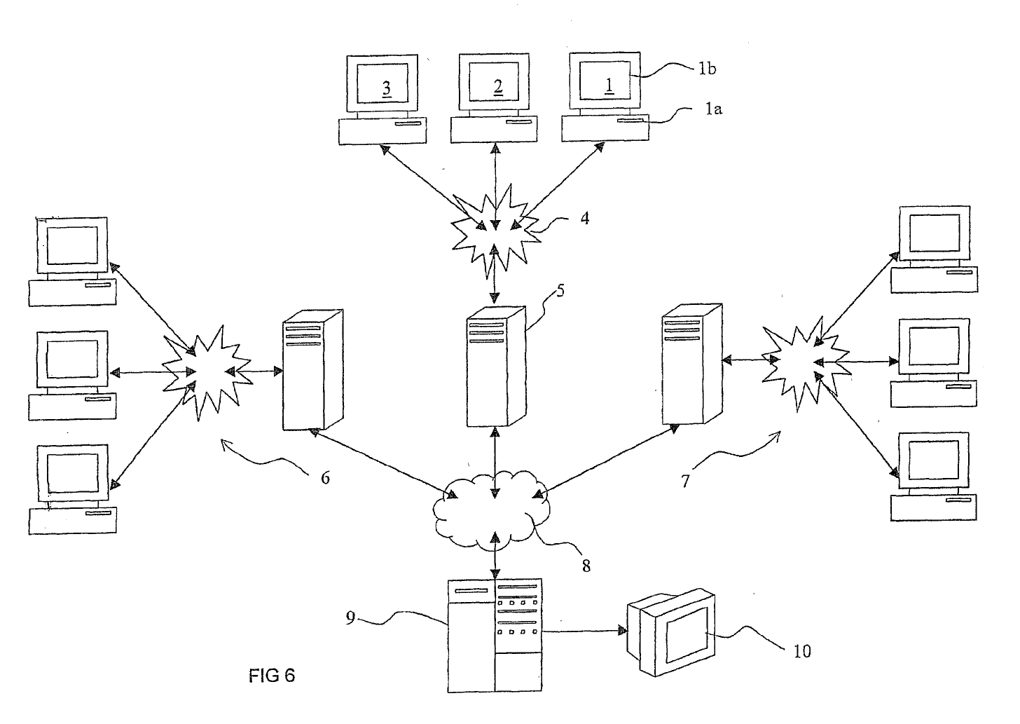

A specific example of the working of the method for a power generation utility is shown in FIG. 5. In a hierarchical structure the utility is considered as formed from two units, a power station and shares. The power station has two power unit components, power unit A and power unit B. Each component contains a number of sub-components, which are shown in FIG. 5 for power unit B. Power unit A will have a similar structure. Each component is modeled to provide a budgeted output for a given input. The specific values for the generator sub-component are shown. The input cost is $4.25 for an actual output value of $5.3333 and a budgeted output of $5.423. This represents a deviation of $0.0897.

This deviation is shown in FIG. 5 in dollar terms. The actual generator model is likely to be constructed on the basis of a mass balance or an energy balance. All inputs and outputs can be given a dollar value to calculate the net dollar value of inputs and the net dollar value of outputs so that the values can be passed to the next component and the deviation value can be passed up the hierarchy.

Similar detail is calculated for each sub-component to obtain the deviations shown. The sub-component deviations are summed to obtain a component deviation, D_{i.tot} of $0.6667. Similarly the power unit A deviation is calculated as $0.3333. These component variations are summed to obtain a unit deviation of D_{i.tot}=$1.00.

The shares are considered in two packets, packet A and packet B. As shown in FIG. 5 the component variations sum to a unit variation of −$0.1. The total deviation for the power utility is $0.90. If this deviation is unacceptable the data can be mined to determine that the major cause of the deviation is the poor efficiency of the condenser and turbine in power unit B.

A suitable environment for working the invention is depicted in FIG. 6. The performance of each component or sub-component is modeled analytically in software that runs on a computer, which in many cases will be a desktop computer, such as 1. The modeling would have three modes of operation within the same analysis structure namely monitoring, optimization and risk assessment. In monitoring mode the actual inputs are used. In optimization mode the controllable parameters are systematically changed and in risk assessment mode, the uncontrolable parameters are systematically changed.

The desktop computer 1 will have processing means 1a that receives a measure of the input values, Xᵢ for calculation of the key performance indicator KPIᵢ. The input values Xᵢ may be converted to corresponding input values Wᵢ in the processing means 1a. The target output value Bᵢ is calculated by the processing means 1a and may be displayed locally on display means 1b. The actual output Zᵢ is also measured and received by the computer 1, and may be converted to corresponding output value Y, in the processing means 1a. The target output Bᵢ, corresponding actual output Yᵢ, and calculated deviation Dᵢ are displayed on the display means 1b. These values, as well as the raw data, are stored in a local storage device in the computer 1.

There may be a separate computer, such as 2, for each component or sub-component. In some circumstances it may be possible for a single computer, such as 3, to monitor two or more key performance indicators.

Each of the computers 1, 2, 3 are connected by a local area network 4 to a unit server 5 which collates the deviations Dᵢ of each component or sub-component within the unit, as well as calculates a total input, total output, and total budget for the unit.

As mentioned above, a business may consist of multiple units so the arrangement may be repeated, such as 6 and 7. The various user servers are connected by a wide area network 8 to a business server 9 that sums the deviations Dᵢ across the business to obtain D_{i.tot}, and calculates Y_{i.tot}, B_{i.tot}, and W_{i.tot}, as described earlier. The business server 9 also calculates the global deviation G and displays the various measures and deviations on display means 10. The display may be graphical and contain time sequences of data against a suitable time base. The raw data may be stored at the business server 9 or in the unit server, such as 5.

The business server may 9 be configured to operate semi-automatically to indicate an alarm if the global deviation G exceeds the threshold T. In this case the user can mine the stored data to identify the component or sub-component that is performing with significant deviation from the target key performance indicator. Communication throughout the system shown in FIG. 6 is therefore two way.

Throughout the specification the aim has been to describe the invention without limiting the invention to any particular combination of alternate features.

1. A method of monitoring the performance of a business including the steps of:
determining key performance indicators for one or more sections of the business;
determining a target value for each key performance indicator;
measuring an actual value for each key performance indicator;
measuring a deviation between the target value and the actual value;
storing the actual value and deviation for each key performance indicator; and
summing the actual values and the deviations to provide a global measure of performance of the business in terms of a global actual value and a global deviation;
wherein a significant global deviation is tracked to one or more contributing key performance indicators to identify the section and/or sections primarily contributing to the global deviation.

2. The method of claim 1 wherein the step of determining a target value for each key performance indicator includes the steps of selecting an appropriate model, setting parameters for the model, and calculating a target value from an input value.

3. The method of claim 2 further including the step of simulating the impact of change on a performance of the business by changing controllable parameters of the model.

4. The method of claim 2 further including the step of simulating the impact of risk on a performance of the business by changing uncontrollable parameters of the model.

5. A method of monitoring the performance of a business including the steps of:
(a) determining input values Xᵢ for each key performance indicator KPIᵢ for each of one or more sub-component of the business;
(b) converting each input value Xᵢ to corresponding input values Yᵢ that are measured in units which are common for all key performance indicators KPIᵢ;
(c) measuring output values Zᵢ for each Xᵢ;
(d) converting each output value Zᵢ to corresponding output values Wᵢ that are measured in units which are common for all key performance indicators KPIᵢ;
(e) calculating a total input Y_{i.tot} for the business which is based on the Yᵢ values of each KPI and the relationship between each KPI of the business;
(f) calculating a total output W_{i.tot} for the business which is based on the Wᵢ values of each KPI and the relationship between each KPI of the business; and
(g) comparing the total output W_{i.tot} to the total input Y_{i.tot} as a measure of performance of the business.

6. The method of claim 5 wherein W_{i.tot} is calculated as the summation of Wᵢ for all i, and Y_{i.tot} is calculated as the summation of Yᵢ for all i.

7. The method of claim 5 further including the steps of:
(h) calculating budget output values Bᵢ from the input values Yᵢ and a model for each KPIᵢ;
(i) calculating a deviation value Dᵢ for each KPIᵢ which is the difference between the budget output value Bᵢ and the actual output value Wᵢ;
(j) calculating a total deviation value D_{i.tot} which is based on the Dᵢ values of each KPIᵢ and the relationship between each KPIᵢ of the business;
(k) comparing the total deviation value D_{i.tot} to a threshold T as a measure of performance of the business.

8. The method of claim 5 further including the steps of:
(h) calculating budget output values Bᵢ from the input values Yᵢ and a model for each KPIᵢ;
(l) calculating a total budget output value B_{i.tot} which is based on the Bᵢ values of each KPIᵢ and the relationship between each KPIᵢ of the business;
(m) calculating a global deviation G between the total budget output value B_{i.tot} and the total output W_{i.tot} for the business; and
(n) comparing the global deviation value G to a threshold T as a measure of performance of the business.

9. The method of claim 8 wherein Bᵢ tot is calculated as the summation of Bᵢ for all i.

10. The method of claim 7, further including the steps of;
(o) mining the deviation values Dᵢ when the total deviation value D_{i.tot} exceeds the threshold T to identify the KPIᵢ or KPIᵢ's that contribute to the total deviation D_{i.tot} in a significant manner.

11. The method of claim 8 further including the steps of:
(p) mining the deviation values Dᵢ when the global deviation G exceeds the threshold T to identify the KPIᵢ or KPIᵢ's that contribute to the global deviation G in a significant manner.

12. The method of claim 7 or 8 further including the step of.
(q) quantifying improvement to the business by systematically changing controllable parameters P_{c} of the model for a KPIᵢ and relating a value of the change to P_{c} to the value associated with W_{i.tot}, and D_{i.tot} or G as a result of the change to P_{c}.

13. The method of claim 7 or 8 further including the step of:
(r) quantifying the risk a business is exposed to by systematically changing uncontrollable parameters Pᵤ of the model for a KPIᵢ within an expected range and relating a value of the change to Pᵤ to the value associated with the W_{i.tot}, D_{i.tot} or G as a result of the change to Pᵤ.

14. A computer implemented method of monitoring the performance of a business including the steps of:
(a) recording input values Xᵢ for each key performance indicator KPIᵢ for each of one or more sub-components of the business;
(b) converting each input value Xᵢ to corresponding input values Yᵢ that are measured in units which are common for all key performance indicators KPIᵢ;
(c) recording output values Zᵢ for each Xᵢ;
(d) converting each output value Z to corresponding output values Wᵢ that are measured in units which are common for all key performance indicators KPIᵢ;
(e) calculating a total input Y_{i.tot} for the business which is based on the Yᵢ values of each KPIᵢ and the relationship between each KPIᵢ of the business;
(f) calculating a total output W_{i.tot} for the business which is based on the Wᵢ values of each KPIᵢ and the relationship between each KPIᵢ of the business; and
(g) comparing the total output W_{i.tot} to the total input Y₁.tot as a measure of performance of the business.

15. The computer implemented method of claim 14 further including the steps of:
(h) calculating budget output values Bᵢ from the input values Yᵢ and a model for each KPIᵢ;
(i) calculating a deviation value Dᵢ for each KPIᵢ which is the difference between the budget output value Bᵢ and the actual output value Wᵢ;
(o) calculating a total deviation value D_{i.tot} which is based on the Dᵢ values of each KPI and the relationship between each KPIᵢ of the business;
(k) comparing the total deviation value D_{i.tot} to a threshold T as a measure of performance of the business; and
(l) displaying on a display means the values D_{i.tot}, T, Y_{i.tot} and W_{i.tot}.

16. The computer implemented method of claim 14 further including the steps of:
(h) calculating budget output values Bᵢ from the input values Yᵢ and a model for each KPIᵢ;
(m) calculating a total budget output value B_{i.tot} which is based on the Bᵢ values of each KPIᵢ and the relationship between each KPIᵢ of the business;
(n) calculating a global deviation G between the total budget output value B_{i.tot} and the total output W_{i.tot} for the business;
(o) comparing the global deviation value G to a threshold T as a measure of performance of the business; and
(p) displaying on a display means the values G, T, B_{i.tot}, W_{i.tot}, and Y_{i.tot}.

17. The method of claim 15 further including the steps of:
(q) mining the deviation values Dᵢ when the total deviation value D_{i.tot} exceeds the threshold T to identify the KPIᵢ or KPIᵢ's that contribute to the total deviation D_{i.tot} in a significant manner.

18. The method of claim 16 further including the steps of:
(r) mining the deviation values Dᵢ when the global deviation G exceeds the threshold T to identify the KPIᵢ or KPli's that contribute to the global deviation G in a significant manner.

19. The computer implemented method of claim 15 or 16 further including the step of:
(s) quantifying improvement to the business by systematically changing controllable parameters P_{c} of the model for a KPIᵢ and relating a value of the change to P_{c} to the value associated with W_{i.tot} and D_{i.tot} or G as a result of the change to P_{c}.

20. The computer implemented method of claim 15 or 16 further including the step of:
(t) quantifying the risk a business is exposed to by systematically changing uncontrollable parameters P^{u} of the model for a KPIᵢ within an expected range and relating a value of the change to Pᵤ to the value associated with the W_{i.tot}, D_{i.tot} or G as a result of the change to Pᵤ.
